(19) United States
(12) Patent Application Publication
(10) Pub. No.: US 2026/0106218 A1
(43) Pub. Date: Apr. 16, 2026

(54) POLYMER ELECTROLYTE AND ELECTROCHEMICAL DEVICE COMPRISING SAME

(71) Applicant: Factorial Inc., Billerica, MA (US)

(72) Inventors: Soyoung An, Burlington, MA (US); Zhangxing Shi, Winchester, MA (US); Yiqing Huang, Lexington, MA (US); Nozomi Horikawa, Somerville, MA (US)

(21) Appl. No.: 19/359,638

(22) Filed: Oct. 15, 2025

Related U.S. Application Data
(60) Provisional application No. 63/708,029, filed on Oct. 16, 2024.

(51) Int. Cl. H01M 10/0565; H01M 4/02; H01M 4/40; H01M 10/052

(52) U.S. Cl. CPC H01M 10/0565; H01M 4/405; H01M 10/052; H01M 2004/027; H01M 2300/0034; H01M 2300/0037; H01M 2300/0085

(57) ABSTRACT

Disclosed herein are precursor solutions, gel polymer electrolytes prepared therefrom, and electrochemical devices comprising the same. In some embodiments, the gel polymer electrolyte comprises an electrolyte salt, a nonaqueous solvent, and a crosslinked polymer obtained from an Aza-Michael addition between a Michael donor with at least two primary amines and a Michael acceptor with at least three carbon-carbon double bond groups, wherein the Michael donor has a molecular weight of no greater than 600 Daltons and is fully dissolved in the precursor solution, and the Michael donor can react with the Michael acceptor via Aza-Michael addition to form a crosslinked polymer. In some embodiments, the nonaqueous solvent is free of groups reactive with lithium metal. In some embodiments, the nonaqueous solvent comprises a fluorinated ether, a fluorine-free ether or mixture thereof. In some embodiments, the electrochemical device comprising the polymer electrolyte exhibits an improved cycling performance.

### CROSS-REFERENCE

The present application claims priority of U.S. Ser. No. 63/708,029, filed Oct. 16, 2024, the entire content of which is incorporated herein by reference into this application.

### TECHNICAL FIELD

The present disclosure generally relates to gel polymer electrolytes and electrochemical devices comprising the same. In some embodiments, the electrochemical devices are lithium metal batteries.

### BACKGROUND

Polymer electrolytes are widely studied to improve the safety of electrochemical devices. An all solid-state polymer electrolyte is substantially free of solvent and exhibits a low ionic conductivity at ambient or low temperature and poor processability. A certain amount of solvent and salt is required to achieve a desirable ionic conductivity. An in situ polymerization of monomer is usually employed to form a polymer or polymer matrix to immobilize solvent and salt, leading to a semi-solid polymer electrolyte or gel polymer electrolyte. Conventional radical initiators such as 2,2′-azobis(2-methylpropionitrile) (AIBN) and benzoyl peroxide (BPO) are usually used for such in situ polymerization. The presence of initiator and its residue, however, may lead to formation of bubbles and other impurities that deteriorate the performance of an electrochemical device such as lithium metal batteries. Aza-Michael addition is employed to form a crosslinked polymer in absence of radical initiators. For example, branched polyethyleneimine (PEI) and linear PEI were demonstrated as a Michael donor for Aza-Michael addition in an alcohol solvent, and branched PEI can lead to a gel polymer electrolyte with a higher ionic conductivity than linear PEI. However, the solubility of Michael donor and the compatibility in electrochemical device are complicated and have not been systematically investigated. PEI has good solubility in alcohol solvents, but alcohol solvents are not stable in high voltage electrochemical devices such as lithium-ion batteries and lithium metal batteries. A high concentration of electrolyte salt is essential for the desired stability and/or ionic conductivity of the electrolyte. However, PEI cannot be dissolved in an electrolyte salt solution with a high concentration of electrolyte salt. Thus, there remains a need for new polymer electrolytes.

### SUMMARY

In one aspect, a gel polymer electrolyte is obtained from Aza-Michael addition of a precursor solution comprising a nonaqueous solvent, an electrolyte salt, a Michael acceptor comprising three or more polymerizable carbon-carbon double bond (C═C) groups and a Michael donor comprising at least two primary amines, wherein the Michael donor has a molecular weight of no greater than 600 Daltons and can be fully dissolved in the precursor solution, and the Michael donor can react with the Michael acceptor via Aza-Michael addition to form a crosslinked polymer. In one aspect, a gel polymer electrolyte comprises a nonaqueous solvent, an electrolyte salt, and a crosslinked polymer obtained from Aza-Michael addition between a Michael acceptor comprising three or more polymerizable carbon-carbon double bond (C═C) groups and a Michael donor comprising at least two primary amines. In some embodiments, the Aza-Michael addition is conducted in the absence of catalyst other than the electrolyte salt.

In some embodiments, the Michael acceptor has a formula selected from the group consisting of

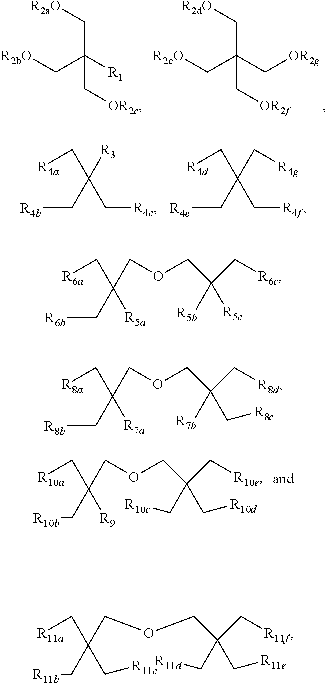

wherein R₁, R₃, R₅ₐ, R_{5b}, R_{5c}, R₇ₐ, R_{7b} and R₉ are each independently selected from the group consisting of H, halogen, —OH, C₁₋₆ alkyl, C₁₋₆ haloalkyl, C₁₋₆ hydroxyalkyl and C₁₋₆ alkoxy,
R₂ₐ, R_{2b}, R_{2c}, R_{2d}, R₂ₑ, R_{2f} and R_{2g} are each independently

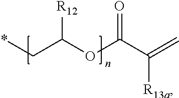

wherein R₁₂ and R₁₃ₐ are each independently selected from the group consisting of H, C₁₋₆ alkyl, C₁₋₆ haloalkyl, C₁₋₆ hydroxyalkyl and C₁₋₆ alkoxy, n is an average value in a range from 0 to 20, * indicates the point of attachment,
R₄ₐ, R_{4b}, R_{4c}, R_{4d}, R_{4c}, R_{4f}, R_{4g}, R₆ₐ, R_{6b}, R_{6c}, R₈ₐ, R_{8b}, R_{8c}, R_{8d}, R₁₀ₐ, R_{10b}, R_{10c}, R_{10d}, R₁₀ₑ, R₁₁ₐ, R_{11b}, R_{11c}, R_{11d}, R₁₁ₑ and R_{11f} are each independently selected from the group consisting of

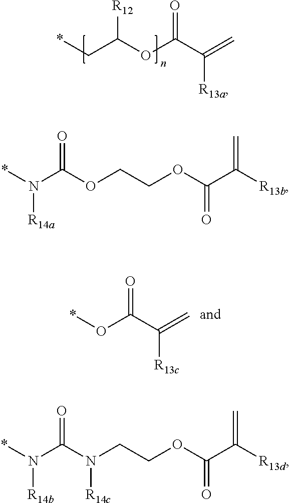

wherein R₁₃ₐ, R_{13b}, R_{13c}, R_{13d}, R₁₄ₐ, R_{14b}, and R_{14c} are each independently selected from the group consisting of H, C₁₋₆ alkyl, C₁₋₆ haloalkyl, C₁₋₆ hydroxyalkyl and C₁₋₆ alkoxy.

In some embodiments, the solubility of Michael donor in the precursor solution is critical to the formation of uniform gel polymer electrolyte. In some embodiments, the Michael donor has a molecular weight of no greater than 600 Daltons and can be fully dissolved in the precursor solution. In some embodiments, the Michael donor is a diamine containing two primary amine groups (—NH₂). In some embodiments, the Michael donor is a triamine containing three primary amine groups (—NH₂).

In some embodiments, an electrochemical device comprising the electrolyte exhibits an improved cycling performance, rate performance, and/or safety.

The term “% by weight” or “percent by weight” refers to the percentage the identified components or components represent with the percent calculated as percent by weight of all components, unless otherwise noted.

The term “alkyl” refers to a saturated acyclic hydrocarbon radical that may be a straight chain or branched chain, containing the indicated number of carbon atoms. For example, C₁₋₁₀ indicates that the group may have from 1 to 10 (inclusive) carbon atoms in it. Non-limiting examples include methyl, ethyl, iso-propyl, tert-butyl, n-hexyl. The term “saturated” as used in this context means only single bonds present between constituent carbon atoms and other available valences occupied by hydrogen and/or other substituents as defined herein.

The term “halogen” refers to fluoro (F), chloro (Cl), bromo (Br), or iodo (I).

The term “oxo” refers to a divalent doubly bonded oxygen atom (i.e., “=O”). As used herein, oxo groups are attached to carbon atoms to form carbonyls.

The term “alkoxy” refers to an —O-alkyl radical (e.g., —OCH₃).

The term “hydroxyalkyl” refers to an alkyl, in which one or more hydrogen atoms is/are replaced with hydroxyl.

The term “haloalkyl” refers to an alkyl, in which one or more hydrogen atoms is/are replaced with an independently selected halogen.

The term “fluoroalkyl” refers to an alkyl, in which one or more hydrogen atoms is/are replaced with a fluorine.

The term “aryl” refers to a 6-20 membered all carbon ring system wherein at least one ring in the system is aromatic (e.g., 6-carbon monocyclic, 10-carbon bicyclic, or 14-carbon tricyclic aromatic ring system). Examples of aryl groups include phenyl, naphthyl, tetrahydronaphthyl, and the like.

The term “carbocyclyl” as used herein refers to cyclic saturated hydrocarbon groups having, e.g., 3 to 20 ring carbons, preferably 3 to 16 ring carbons, and more preferably 3 to 12 ring carbons or 3-10 ring carbons or 3-6 ring carbons. Examples of cycloalkyl groups include, without limitation, cyclopropyl, cyclobutyl, cyclopentyl, cyclohexyl, cycloheptyl, and cyclooctyl. Cycloalkyl may include multiple fused and/or bridged rings. Non-limiting examples of fused/bridged cycloalkyl includes: bicyclo[1.1.0]butane, bicyclo[2.1.0]pentane, bicyclo[1.1.1]pentane, bicyclo[3.1.0]hexane, bicyclo[2.1.1]hexane, bicyclo[3.2.0]heptane, bicyclo[4.1.0]heptane, bicyclo[2.2.1]heptane, bicyclo[3.1.1]heptane, bicyclo[4.2.0]octane, bicyclo[3.2.1]octane, bicyclo[2.2.2]octane, and the like. Cycloalkyl also includes spirocyclic rings (e.g., spirocyclic bicycle wherein two rings are connected through just one atom). Non-limiting examples of spirocyclic cycloalkyls include spiro[2.2]pentane, spiro[2.5]octane, spiro[3.5]nonane, spiro[3.5]nonane, spiro[3.5]nonane, spiro[4.4]nonane, spiro[2.6]nonane, spiro[4.5]decane, spiro[3.6]decane, spiro[5.5]undecane, and the like. The term “saturated” as used in this context means only single bonds present between constituent carbon atoms.

The term “heteroaryl”, as used herein, refers to a ring system having 5 to 20 ring atoms, such as 5, 6, 9, 10, or 14 ring atoms; wherein at least one ring in the system contains one or more heteroatoms independently selected from the group consisting of N, O, S, Si, and B, and at least one ring in the system is aromatic (but does not have to be a ring which contains a heteroatom, e.g. tetrahydroisoquinolinyl, e.g., tetrahydroquinolinyl). Heteroaryl groups can include monocyclic, bridged, fused, and spiro ring systems, so long as one ring in the system is aromatic. Examples of heteroaryl include thienyl, pyridinyl, furyl, oxazolyl, oxadiazolyl, pyrrolyl, imidazolyl, triazolyl, thiodiazolyl, pyrazolyl, isoxazolyl, thiadiazolyl, pyranyl, pyrazinyl, pyrimidinyl, pyridazinyl, triazinyl, thiazolyl benzothienyl, benzoxadiazolyl, benzofuranyl, benzimidazolyl, benzotriazolyl, cinnolinyl, indazolyl, indolyl, isoquinolinyl, isothiazolyl, naphthyridinyl, purinyl, thienopyridinyl, pyrido[2,3-d]pyrimidinyl, pyrrolo[2,3-b]pyridinyl, quinazolinyl, quinolinyl, thieno[2,3-c]pyridinyl, pyrazolo[3,4-b]pyridinyl, pyrazolo[3,4-c]pyridinyl, pyrazolo[4,3-c]pyridine, pyrazolo[4,3-b]pyridinyl, tetrazolyl, chromane, 2,3-dihydrobenzo[b][1,4]dioxine, benzo[d][1,3]dioxole, 2,3-dihydrobenzofuran, tetrahydroquinoline, 2,3-dihydrobenzo[b][1,4]oxathiine, isoindoline, and others. In some embodiments, the heteroaryl is selected from thienyl, pyridinyl, furyl, pyrazolyl, imidazolyl, isoindolinyl, pyranyl, pyrazinyl, and pyrimidinyl. For purposes of clarification, heteroaryl also includes aromatic lactams, aromatic cyclic ureas, or vinylogous analogs thereof, in which each ring nitrogen adjacent to a carbonyl is tertiary (i.e., all three valences are occupied by non-hydrogen substituents), such as one or more of pyridine, wherein each ring nitrogen adjacent to a carbonyl is tertiary (i.e., the oxo group (i.e., “—O”) herein is a constituent part of the heteroaryl ring).

The term “heterocyclyl” refers to a saturated or partially unsaturated ring systems with 3-16 ring atoms (e.g., 3-8 membered monocyclic, 5-12 membered bicyclic, or 10-14 membered tricyclic ring system) having at least one heteroatom selected from O, N, S, Si, and B, wherein one or more ring atoms may be substituted by 1-3 oxo (forming, e.g., a lactam) and one or more N or S atoms may be substituted by 1-2 oxido (forming, e.g., an N-oxide, an S-oxide, or an S,S-dioxide), valence permitting. Heterocyclyl groups include monocyclic, bridged, fused, and spiro ring systems. Examples of heterocyclyl groups include piperazinyl, pyrrolidinyl, dioxanyl, morpholinyl, tetrahydrofuranyl, tetrahydropyridyl, dihydropyrazinyl, dihydropyridyl, dihydropyrrolyl, dihydrofuranyl, dihydrothiophenyl, and the like. Heterocyclyl may include multiple fused and bridged rings. Non-limiting examples of fused/bridged heteorocyclyl includes: 2-azabicyclo[1.1.0]butane, 2-azabicyclo[2.1.0]pentane, 2-azabicyclo[1.1.1]pentane, 3-azabicyclo[3.1.0]hexane, 5-azabicyclo[2.1.1]hexane, 3-azabicyclo[3.2.0]heptane, octahydrocyclopenta[c]pyrrole, 3-azabicyclo[4.1.0]heptane, 7-azabicyclo[2.2.1]heptane, 6-azabicyclo[3.1.1]heptane, 7-azabicyclo[4.2.0]octane, 2-azabicyclo[2.2.2]octane, 3-azabicyclo[3.2.1]octane, 2-oxabicyclo[1.1.0]butane, 2-oxabicyclo[2.1.0]pentane, 2-oxabicyclo[1.1.1]pentane, 3-oxabicyclo[3.1.0]hexane, 5-oxabicyclo[2.1.1]hexane, 3-oxabicyclo[3.2.0]heptane, 3-oxabicyclo[4.1.0]heptane, 7-oxabicyclo[2.2.1]heptane, 6-oxabicyclo[3.1.1]heptane, 7-oxabicyclo[4.2.0]octane, 2-oxabicyclo[2.2.2]octane, 3-oxabicyclo[3.2.1]octane, and the like. Heterocyclyl also includes spirocyclic rings (e.g., spirocyclic bicycle wherein two rings are connected through just one atom). Non-limiting examples of spirocyclic heterocyclyls include 2-azaspiro[2.2]pentane, 4-azaspiro[2.5]octane, 1-azaspiro[3.5]nonane, 2-azaspiro[3.5]nonane, 7-azaspiro[3.5]nonane, 2-azaspiro[4.4]nonane, 6-azaspiro[2.6]nonane, 1,7-diazaspiro[4.5]decane, 7-azaspiro[4.5]decane 2,5-diazaspiro[3.6]decane, 3-azaspiro[5.5]undecane, 2-oxaspiro[2.2]pentane, 4-oxaspiro[2.5]octane, 1-oxaspiro[3.5]nonane, 2-oxaspiro[3.5]nonane, 7-oxaspiro[3.5]nonane, 2-oxaspiro[4.4]nonane, 6-oxaspiro[2.6]nonane, 1,7-dioxaspiro[4.5]decane, 2,5-dioxaspiro[3.6]decane, 1-oxaspiro[5.5]undecane, 3-oxaspiro[5.5]undecane, 3-oxa-9-azaspiro[5.5]undecane and the like.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 shows the charge rate performance of Li/NMC cell according to some embodiments of the present disclosure.

FIG. 2A shows the cycling performance of a pouch cell comprising Example 3-2 as electrolyte in view of specific discharge capacity according to one embodiment of the present disclosure.

FIG. 2B shows the cycling performance of a pouch cell comprising Example 3-2 as electrolyte in view of discharge capacity retention according to one embodiment of the present disclosure.

FIG. 2C shows the cycling performance of a pouch cell comprising Example 3-2 as electrolyte in view of Coulombic efficiency (CE) according to one embodiment of the present disclosure.

### DETAILED DESCRIPTION

The present disclosure generally relates to gel polymer electrolytes suitable for various electrochemical devices. In some embodiments, the electrochemical devices are lithium metal batteries.

In one aspect, disclosed is a gel polymer electrolyte obtained from Aza-Michael addition of a precursor solution comprising a nonaqueous solvent, an electrolyte salt, a Michael acceptor comprising three or more polymerizable carbon-carbon double bond (C═C) groups and a Michael donor comprising at least two primary amines, wherein the Michael donor has a molecular weight of no greater than 600 Daltons and is fully dissolved in the precursor solution, and the Michael donor reacts with the Michael acceptor via Aza-Michael addition to form a crosslinked polymer. In some embodiments, the Aza-Michael addition is conducted in the absence of catalyst other than the electrolyte salt.

In some embodiments, the Michael acceptor has a formula selected from the group consisting of

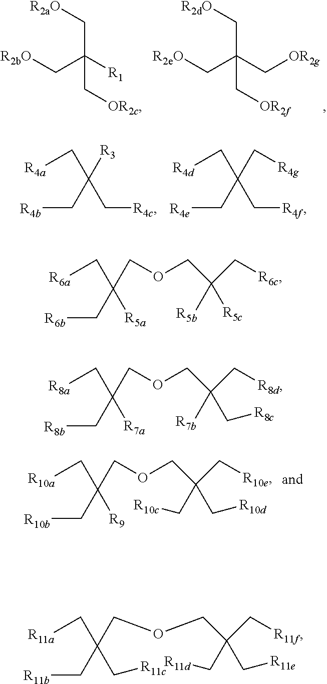

wherein R₁, R₃, R₅ₐ, R_{5b}, R_{5c}, R₇ₐ, R_{7b} and R₉ are each independently selected from the group consisting of H, halogen, —OH, C₁₋₆ alkyl, C₁₋₆ haloalkyl, C₁₋₆ hydroxyalkyl and C₁₋₆ alkoxy,
R₂ₐ, R_{2b}, R_{2c}, R_{2d}, R₂ₑ, R_{2f} and R_{2g} are each independently

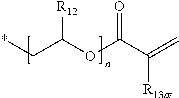

wherein R₁₂ and R₁₃ₐ are each independently H, C₁₋₆ alkyl, C₁₋₆ haloalkyl, C₁₋₆ hydroxyalkyl and C₁₋₆ alkoxy, n has an value in a range from 0 to 20, * indicates the point of attachment,
R₄ₐ, R_{4b}, R_{4c}, R_{4d}, R₄ₑ, R_{4f}, R_{4g}, R₆ₐ, R_{6b}, R_{6c}, R₈ₐ, R_{8b}, R_{8c}, R_{8d}, R₁₀ₐ, R_{10b}, R_{10c}, R_{10d}, R₁₀ₑ, R₁₁ₐ, R_{11b}, R_{11c}, R_{11d}, R₁₁ₑ and R_{11f} are each independently selected from the group consisting of

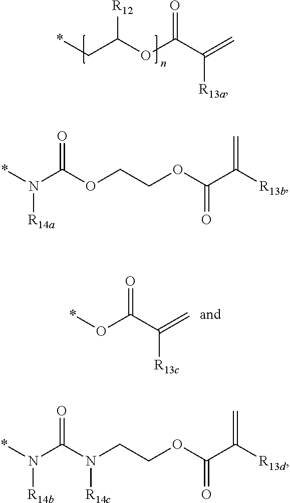

wherein R₁₃ₐ, R_{13b}, R_{13c}, R_{13d}, R₁₄ₐ, R_{14b}, and R_{14c} are each independently selected from the group consisting of H, C₁₋₆ alkyl, C₁₋₆ haloalkyl, C₁₋₆ hydroxyalkyl and C₁₋₆ alkoxy.

In some embodiments, the Michael donor contains two or more primary amine groups (—NH₂). In some embodiments, the Michael donor can be fully dissolved in a precursor solution comprising an electrolyte salt, a nonaqueous solvent, and a Michael acceptor. In some embodiments, the Michael donor has a molecular weight of no greater than 600 Daltons. In some embodiments, the Michael donor contains a polyether backbone, which is based on either ethylene oxide (EO), propylene oxide (PO), or a combination thereof. In some embodiments, the Michael donor contains two or more primary amine groups attached to the end of a polyether backbone, wherein the polyether backbone is based on either ethylene oxide (EO), propylene oxide (PO), or a combination thereof. In some embodiments, the Michael donor contains three or more amine groups attached to the end of a polyether backbone.

In some embodiments, the Michael donor is a diamine with a formula of

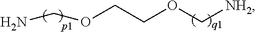

wherein p1 and q1 independently have a value in a range from 1.0 to 20.0 and 1≤p1+q1≤30.

In some embodiments, the Michael donor is a diamine with a formula of

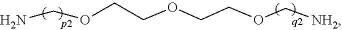

wherein p2 and q2 independently have a value in a range from 1.0 to 20.0 and 1≤p2+q2≤30.

In some embodiments, the Michael donor is a diamine with a formula of

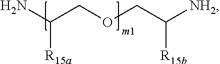

wherein R₁₅ₐ and R_{15b} are each independently selected from the group consisting of H, —CH₃, and —C₂H₅, and m1 is an average value of the repeating units and has a value in a range from 1.0 to 12.

In some embodiments, the Michael donor is a diamine with a formula of

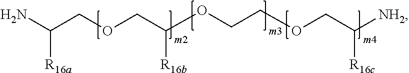

wherein R₁₆ₐ, R_{16b} and R_{16c} are each independently selected from the group consisting of —CH₃ and —C₂H₅, 1≤m2≤10.0, 1≤m3≤10.0, 1≤m4≤10.0, and 1≤m2+m3+m4≤12.0.

In some embodiments, the Michael donor is a triamine with a formula of

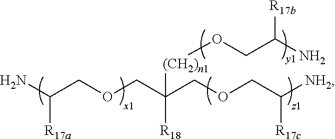

wherein R₁₇ₐ, R_{17b} and R_{17c} are each independently selected from the group consisting of H, —CH₃ and —C₂H₅, R₁₈ is selected from the group consisting of H, halogen, —OH, C₁₋₆ alkyl, C₁₋₆ haloalkyl, C₁₋₆ hydroxyalkyl and C₁₋₆ alkoxy, 0≤x1≤5.0, 0≤y1≤5.0, 0≤z1≤5.0, 0≤n1≤5.0, 1.0≤x1+y1+z1≤10.0.

In some embodiments, the Michael donor is a tetramine with a formula of

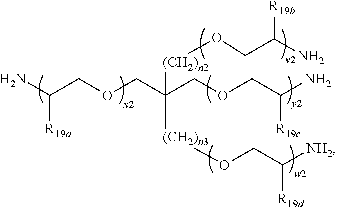

wherein R₁₉ₐ, R_{19b}, R_{19c} and R_{19d} are each independently selected from the group consisting of H, —CH₃ and —C₂H₅, 0≤x2≤5.0, 0≤y2≤50.0, 0≤v2≤5.0, 0≤w2≤5.0, 0≤n2≤5.0, 0≤n3≤5.0, and 1.0≤x2+y2+v2+w2≤10.0.

In some embodiments, the Michael donor is a diamine or triamine. In some embodiments, the Michael donor comprises at least one selected from the group consisting of, tris(2-aminoethyl)amine, 1,1,1-tris(aminomethyl) ethane, ethylenediamine, hexamethylenediamine, nonamethylenediamine, 1,3,5-triazine-2,4-diamine, 6-methyl-1,3,5-triazine-2,4-diamine, cycloheptane-1,4-diamine, oxolane-3,4-diamine, 4,7,10-trioxa-1,13-tridecanediamine (TTDDA), poly(ethylene glycol)diamine (Mn=100-600), poly(oxypropylene)diamine (Mn=100-600), pentane-1,3,5-triamine, tris(2-aminoethyl)amine, tris(2-aminopropyl)amine, and a mixture thereof.

In some embodiments, the incorporation of polymer into the gel electrolyte reduces or prevents the leakage of liquid components therein. In some embodiments, the gel polymer electrolyte comprises a crosslinked polymer with a weight percentage in a range from 0.02 wt % to 15.0 wt %, from 0.05 wt % to 15.0 wt %, from 0.1 wt % to 15.0 wt %, from 0.2 wt % to 15.0 wt %, from 0.5 wt % to 15.0 wt %, from 1.0 wt % to 15.0 wt %, from 2.0 wt % to 15.0 wt %, from 3.0 wt % to 15.0 wt %, or from 5.0 wt % to 15.0 wt % in the gel polymer electrolyte. In some embodiments, the gel polymer electrolyte comprises a crosslinked polymer with a weight percentage in a range from 0.02 wt % to 40.0 wt %, from 0.02 wt % to 30.0 wt %, from 0.02 wt % to 20.0 wt %, from 0.02 wt % to 10.0 wt %, from 0.05 wt % to 40.0 wt %, from 0.05 wt % to 30.0 wt %, from 0.05 wt % to 20.0 wt %, from 0.05 wt % to 10.0 wt %, from 0.1 wt % to 40.0 wt %, from 0.1 wt % to 30.0 wt %, from 0.1 wt % to 20.0 wt %, from 0.1 wt % to 10.0 wt %, from 0.2 wt % to 40.0 wt %, from 0.2 wt % to 30.0 wt %, from 0.2 wt % to 20.0 wt %, from 0.2 wt % to 10.0 wt %, from 0.5 wt % to 40.0 wt %, from 0.5 wt % to 30.0 wt %, from 0.5 wt % to 20.0 wt %, from 0.5 wt % to 10.0 wt %, from 1.0 wt % to 40.0 wt %, from 1.0 wt % to 30.0 wt %, from 1.0 wt % to 20.0 wt %, or from 1.0 wt % to 10.0 wt % in the gel polymer electrolyte.

In some cases, the polymer electrolyte may include a crosslinked polymer obtained from Aza-Michael addition between a Michael donor with an amine and a Michael acceptor with three or more carbon-carbon double bond groups. In certain embodiments, the Michael acceptor comprises a tri-acrylate, tetra-acrylate, modified tri-acrylate, modified tetra-acrylate, or mixtures thereof. In certain embodiments, modified tri-acrylates and tetra-acrylates comprise one or more substituted groups such as —CN, —OH, —OMe, —CO₂—, F, Cl, Br, or I.

In certain embodiments, the Michael acceptor with three or more carbon-carbon double bonds has three or more arms connected to a center, wherein each arm comprises one carbon-carbon double bond. In some embodiments, the center can be an element of C, Si, N, P, B, or a cyclic ring. In some embodiments, a cyclic ring as a center may be an aryl ring, heteroaryl ring, carbocyclic ring, and heterocyclic ring. In some embodiments, the center can be Si or siloxane such as polyoctahedral silsesquioxanes (POSS). In some embodiments, the center is a triazine-trione.

In some embodiments, each carbon-carbon double bond is covalently connected to the center directly or via a spacer chain or group. In some embodiments, each arm is the same or different from each other.

In some embodiments, the spacer chains or groups contain a structure including, but not limited to, —O—, —NR^{c}—, —S—, —C(═O)—, —C(═O)O—, —C(═O)NR^{c}—, —C(═O)S—, —OC(═O)O—, —NR^{c}C(═O)O—, —NR^{c}C(═O)NR^{c}—, —S(═O)—, —S(═O)₂—, —OS(═O)₂—, —OS(═O)₂O—, —NR^{c}S(═O)₂—, —NR^{c}S(═O)₂NR^{c}—, —OS(═O)₂NR^{d}—, C₁₋₆ alkylenyl, C₂₋₆ alkenylenyl, C₂₋₆ alkynylenyl, C₆₋₁₄ arylenyl, 5- to 14-membered heteroarylenyl, C₃₋₁₀ carbocyclenyl, or 3- to 10-membered heterocyclenyl, wherein the alkylenyl, alkenylenyl, alkynylenyl, arylenyl, heteroarylenyl, carbocyclenyl, or heterocyclenyl is optionally substituted with halogen, —CN, —NO₂, C₁₋₆ alkyl, C₁₋₆ haloalkyl, C₁₋₆ hydroxyalkyl, C₁₋₆ aminoalkyl, C₂-6 alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)₂R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}; wherein R^{a}, R^{b}, R^{c}, and R^{d} are independently C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₃₋₁₀ carbocyclyl, 3- to 10-membered heterocyclyl, C₆₋₁₄ aryl, or 5- to 14-membered heteroaryl, wherein the alkyl, haloalkyl, hydroxyalkyl, aminoalkyl, alkenyl, alkynyl, carbocyclyl, heterocyclyl, aryl, and heteroaryl is optionally substituted with one or more oxo, halogen, —CN, —OH, —OMe, —C(═O)Me, —C(═O)OMe, C₁₋₆ alkyl, or C₁₋₆ haloalkyl.

In some embodiments, R^{c} and R^{d}, together with the hetero atom (such as N, O, S, P), form a 3- to 10-membered heterocyclyl, wherein the heterocyclyl is optionally substituted with one or more oxo, halogen, —CN, —OH, —OMe, —C(═O)Me, —C(═O)OMe, C₁₋₆ alkyl, or C₁₋₆ haloalkyl.

In certain embodiments, the spacer chains or groups comprise a structure of —XC(═O)CR³═C(R⁴)₂, wherein X is independently —O— or —NRe—, Re is independently H or C₁₋₆ alkyl, and each R³ and R⁴ is independently H or C₁₋₆ alkyl.

In certain embodiments, the Michael acceptor comprises one or more selected from the group consisting of CH₂═CH—C(═O)CH₂—, CH₂═C(CH₃)—C(═O)CH₂—, CH₂═CH—C(═O)O—, CH₂═C(CH₃)—C(═O)O—, CH₂═CH—C(═O)NH—, and CH₂═C(CH₃)—C(═O)NH—.

Due to the high reactivity between acryloyl carbon-carbon double bond (e.g., CH2═CH—C(═O)—) and primary amine (—NH₂), the Aza-Michael reaction therebetween can be performed in the absence of catalysts such as strong Lewis acid and transition metal catalyst.

In some embodiments, the Michael acceptor comprises at least one selected from the group consisting of pentaerythritol tetra[meth]acrylate, tris[2-(acryloyloxy)ethyl]isocyanurate (TAEI), di(trimethylolpropane)tetra[meth]acrylate, trimethylolpropane propoxylate tri[meth]acrylate, trimethylolpropane tri[meth]acrylate, pentaerythritol tri[meth]acrylate, dipentaerythritol hexa[meth]acrylate, and a mixture thereof.

In some embodiments, the carbon-carbon double bonds (C═C) of the Michael acceptor and the amine group in the Michael donor have a molar ratio in a range from 1.0 to 2.0, from 1.0 to 1.9, from 1.0 to 1.8, from 1.0 to 1.7, from 1.0 to 1.6, from 1.0 to 1.5, from 1.1 to 2.0, from 1.1 to 1.9, from 1.1 to 1.8, from 1.1 to 1.7, from 1.1 to 1.6, from 1.1 to 1.5, from 1.2 to 2.0, from 1.2 to 1.9, from 1.2 to 1.8, from 1.2 to 1.7, from 1.2 to 1.6, from 1.2 to 1.5, from 1.3 to 2.0, from 1.3 to 1.9, from 1.3 to 1.8, from 1.3 to 1.7, from 1.3 to 1.6, from 1.3 to 1.5, from 1.4 to 2.0, from 1.4 to 1.9, from 1.4 to 1.8, from 1.4 to 1.7, from 1.4 to 1.6, from 1.4 to 1.5, from 1.5 to 2.0, from 1.5 to 1.9, from 1.5 to 1.8, from 1.5 to 1.7, or from 1.5 to 1.6.

In some embodiments, the crosslinked polymer has a weight percentage in a range from 3.0 wt % to 15.0 wt % based on total weight of the gel polymer electrolyte. In some embodiments, the crosslinked polymer has a weight percentage in a range from 0.02 wt % to 40.0 wt % in the gel polymer electrolyte.

In some embodiments, the gel polymer electrolyte exhibits an ionic conductivity of at least 1.0 mS/cm or at least 2.0 mS/cm at 25° C. Wang J et al prepared a polymer electrolyte obtained by a Michael acceptor that is a diacrylate exhibited a poor ionic conductivity of no higher than 0.1 mS/cm at 30° C. [Wang J et al, ACS Applied Polymer Materials 6.4 (2024): 2041-2048; Wang J, et al., Macromolecules 56.6 (2023): 2484-2493]. The poor ionic conductivity makes them not suitable for practical battery applications at ambient or low temperature. CN111944099A developed polymer electrolytes with PEI as Michael donor and alcohol as solvent. However, PEI is not soluble in a practical precursor solution with stable solvent such as ether especially when the electrolyte salt is present at a high concentration. A high concentration of electrolyte salt is essential for the desired stability and/or ionic conductivity of the electrolyte.

In some embodiments, the gel polymer electrolyte is obtained by an in situ polymerization after injecting a precursor solution comprising an electrolyte salt, a nonaqueous solvent, a Michael donor and a Michael acceptor into an assembly comprising a cathode, an anode and a separator therebetween.

In some embodiments, the gel polymer electrolyte is obtained by an in situ polymerization after applying a precursor solution comprising an electrolyte salt, a nonaqueous solvent, a Michael donor and a Michael acceptor to a separator to form a coating thereon followed by a polymerization to form an electrolyte-separator assembly.

### Solvent

In some embodiments, the nonaqueous solvent comprises at least one selected from the group consisting of diethyl ether, dimethoxy methane, diethoxy methane, dimethoxy ethane, 1,2-diethoxyethane, 1,1-diethoxyethane, 1,1-dipropoxyethane, 1,2-dipropoxyethane, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, tetrahydrofuran, dioxolane, tetrahydropyran, 1,4-dioxane, 1,3-dioxane, ethylene carbonate, diethyl carbonate, dimethyl carbonate, ethyl methyl carbonate, propylene carbonate, fluoroethylene carbonate, vinylene carbonate, succinonitrile, glutaronitrile, hexanenitrile, malononitrile, dimethyl sulfoxide, 1,3-propane sultone, sulfolane, dimethyl sulfone, ethyl methyl sulfone, ethyl vinyl sulfone, vinyl sulfone, methyl vinyl sulfone, phenyl vinyl sulfone, N-propyl-N-methylpyrrolidinium bis(fluorosulfonyl)imide, N-butyl-N-methylpyrrolidinium bis(fluorosulfonyl)imide, N-propyl-N-methylpiperidinium bis(fluorosulfonyl)imide, 1-methyl-1-(2-methoxyethyl)pyrrolidinium bis(fluorosulfonyl)imide, 1-ethyl-3-methylimidazolium bis(fluorosulfonyl)imide, trimethyl phosphate, triethyl phosphate, poly(ethylene oxide), and a combination thereof.

In some embodiments, the nonaqueous solvent has a weight percentage in a range from 10.0 wt % to 90 wt % in the gel polymer electrolyte.

In some embodiments, the nonaqueous solvent is substantially free of ester-based solvent, carbonate-based solvent, and nitrile-based solvent.

In some embodiments, the nonaqueous solvent comprises a fluorinated ether, fluorine-free ether, or a mixture thereof.

### Fluorine-Free Ether

In some embodiments, the fluorine-free ether has Formula (I):

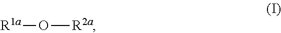

wherein R^{1a} is C₁₋₁₀ alkyl and R^{2a} is C₁₋₁₀ alkyl or —(CH₂)ₙ—O—(C₁₋₁₀ alkyl); or R^{1a} and R^{2a}, together with the oxygen atom therebetween form a 4-7 membered heterocyclyl, wherein n is an integer in a range from 1 to 5.

In some embodiments, the fluorine-free ether includes no more than two oxygen elements. In some embodiments, R^{1a} is C₁-C₆ alkyl. In some embodiments, R^{1a} is methyl, ethyl, or propyl.

In some embodiments, the fluorine-free ether does not comprise 1,2-dimethoxyethane (DME).

In some embodiments, R^{2a} is C₁₋₆ alkyl. In some embodiments, R^{2a} is methyl, ethyl, or propyl.

In some embodiments, R^{2a} is —(CH₂)ₙ—O—(C₁₋₁₀ alkyl). In some embodiments, R^{2a} is —(CH₂)ₙ—O—(C₁₋₆ alkyl). In some embodiments, R^{2a} is —(CH₂)ₙ—O—(C₁₋₃ alkyl). In some embodiments, R^{2a} is —(CH₂)ₙ—O—(C₁ alkyl), —(CH₂)ₙ—O—(C₂ alkyl), or —(CH₂)ₙ—O—(C₃ alkyl). In some embodiments, R^{2a} is —(CH₂)₂—O—(C₁ alkyl), —(CH₂)₂—O—(C₂ alkyl), or —(CH₂)₂—O—(C₃ alkyl).

In some embodiments, R^{1a} and R^{2a}, together with the oxygen atom to which they are attached form a 4-7 membered heterocyclyl. In some embodiments, R^{1a} and R^{2a}, together with the oxygen atom to which they are attached form a 4-7 membered heterocyclyl, wherein the heterocyclyl includes one or two oxygen heteroatoms. In some embodiments, n is 1. In some embodiments, n is 2.

In some embodiments, the fluorine-free ether may not include any halogen elements. In some embodiments, the fluorine-free ether may include one or more non-fluorine halogen elements such as chlorine (Cl), bromine (Br), and iodine (I).

In some embodiments, the fluorine-free ether comprises at least one selected from the group consisting of 1,2-diethoxyethane, 1,1-diethoxyethane, 1,1-dipropoxyethane, 1,2-dipropoxyethane, 1,2-dibutoxyethane, dibutyl ether, di-tert-butyl ether, tert-butyl ethyl ether, tert-butyl methyl ether, 1,3-dioxolane, 1,4-dioxane and mixtures thereof.

In some embodiments, the nonaqueous solvent is substantially free of 1,2-dimethoxyethane (DME). As used herein, the term “substantially free of” an ingredient(s) as provided throughout the disclosure is intended to mean that the composition or device contain less than about 0.1 wt % (percent by weight of the total weight of the composition or device(s)), or insignificant or negligible amounts of said ingredient(s) unless specifically indicated otherwise. In some embodiments, the compositions or devices of the present disclosure are substantially free of 1,2-dimethoxyethane, meaning that the compositions or devices contains less than about 0.1 wt % 1,2-dimethoxyethane.

In some embodiments, the fluorine-free ether has a weight percentage in a range from 10 to 80 wt % in the electrolyte.

The electrolyte can comprise the fluorine-free ether in an amount in a range from 5 wt % to about 90 wt %. For example, the solvent comprises the fluorine-free ether in an amount in a range from about 10 wt % to about 90 wt %, from about 20 wt % to about 80 wt %, from about 25 wt % to about 70 wt %, from about 25 wt % to about 45 wt %, or from about 50 wt % to about 80 wt %. In some embodiments, the solvent comprises the fluorine-free ether in an amount in a range from about 25 wt % to about 45 wt % or from about 30 wt % to about 40 wt %.

### Fluorinated Ether

In some embodiments, the fluorinated ether is an ether with a formula (III):

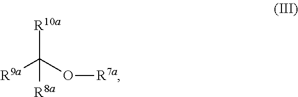

wherein R^{7a} is selected from the group consisting of C₁₋₁₀ alkyl, C₁₋₁₀ fluoroalkyl, —[(C₁₋₄ alkylene)-O-]ₓ—(C₁₋₁₀ alkyl), and —[(C₁₋₄ alkylene)-O-]ₓ—(C₁₋₁₀ fluoroalkyl), R^{8a}, R^{9a} and R^{10a} are independently selected from the group consisting of H, F, C₁₋₁₀ alkyl, C₁₋₁₀ fluoroalkyl, —O—(C₁₋₁₀ alkyl), —O—(C₁₋₁₀ fluoroalkyl), —[(C₁₋₄ alkylene)-O-]_{y}—(C₁₋₁₀ alkyl), —[(C₁₋₄ alkylene)-O-]_{y}—(C₁₋₁₀ fluoroalkyl), —O—[(C₁₋₄ alkylene)-O-]_{y}—(C₁₋₁₀ alkyl), and —O—[(C₁₋₄ alkylene)-O-]_{y}—(C₁₋₁₀ fluoroalkyl), x and y are independently an integer in a range from 1 to 10, and at least one of R^{7a}, R^{8a}, R^{9a} and R^{10a} comprises one or more fluorine (F).

In some embodiments, R^{7a} is C₁₋₁₀ alkyl or C₁₋₁₀ fluoroalkyl. In some embodiments, R^{7a} is C₁₋₆ alkyl such as methyl, ethyl and propyl. In some embodiments, R^{7a} is C₁₋₆ fluoroalkyl including without limitation —CF₃, —CH₂—CHF₂ or —CF₂CH₃.

In some embodiments, R^{7a} is —[(C₁₋₄ alkylene)-O-]ₓ-C₁₋₁₀ alkyl, —[(C₁₋₄ alkylene)-O-]ₓ-C₁₋₁₀ fluoroalkyl, —[(C₁₋₄ alkylene)-O-]_{X}-C₁₋₆ alkyl or —[(C₁₋₄ alkylene)-O-]_{X}-C₁₋₆ fluoroalkyl. In some embodiments, R^{7a} is —CH₂OC₁₋₆ alkyl, —[CH₂]₂OC₁₋₆ alkyl, —CH₂OCH₂OC₁₋₆ alkyl, —C₂H₄O[CH₂]₂OC₁₋₆ alkyl, —CH₂OC₁₋₆ fluoroalkyl, —[CH₂]₂OC₁₋₆ fluoroalkyl, —CH₂OCH₂OC₁₋₆ fluoroalkyl, or —[CH₂]₂O[CH₂]₂OC₁₋₆ fluoroalkyl. In some embodiments, C₁₋₄ alkylene can be —CH₂—, —CH₂CH₂—, —CH₂CH₂CH₂—, —CH₂CH₂CH₂CH₂—, —CH(CH₃)—, —CH(C₂H₅)—, —CH(CH₃)CH₂—, —C(CH₃)₂—, —CH(CH₃)CH₂CH₂—, —CH(CH₂C₂H₅)CH₂—, —CH[CH(CH₃)₂]—, —C(CH₃)₂CH₂—, or —CH(CH₃)CH(CH₃)—.

In some embodiments, R^{8a} is H. In some embodiments, R^{8a} is C₁₋₁₀ alkyl or C₁₋₁₀ fluoroalkyl. In some embodiments, R^{8a} is C₁₋₆ alkyl such as methyl, ethyl and propyl. In some embodiments, R^{8a} is C₁₋₆ fluoroalkyl including without limitation —CF₃, —CH₂CHF₂ or —CF₂CH₃.

In some embodiments, R^{8a} is C₁₋₁₀ alkoxy, i.e., —OC₁₋₁₀ alkyl. In some embodiments, R^{8a} is —C₁₋₆ alkoxy. In some embodiments, R^{8a} is C₁₋₃ alkoxy such as —OCH₃, —OC₂H₅, and —OC₂H₄CH₃. In some embodiments, R^{8a} is —OC₁₋₁₀ fluoroalkyl. In some embodiments, R^{8a} is —OC₁₋₆ fluoroalkyl. In some embodiments, R^{8a} is —OC₁₋₃ fluoroalkyl such as —OCF₃, —OCH₂CHF₂, —OCH₂CF₃, —OCHFCF₃, —CF₂CF₃, —OCH₂CH₂CF₃, —OCH₂CHFCF₃, —OCH₂CF₂CF₃, and —OCHFCF₂CF₃.

In some embodiments, R^{8a} is —[(C₁₋₄ alkylene)-O-]ₓ-C₁₋₁₀ alkyl or —[(C₁₋₄ alkylene)-O-]ₓ-C₁₋₁₀ fluoroalkyl. In some embodiments, R^{8a} is —[(C₁₋₄ alkylene)-O-]ₓ-C₁₋₆ alkyl or —[(C₁₋₄ alkylene)-O-]ₓ-C₁₋₆ fluoroalkyl. In some embodiments, R^{8a} is —CH₂OC₁₋₆ alkyl, —C₂H₄OC₁₋₆ alkyl, —CH₂OCH₂OC₁₋₆ alkyl, —CH₂CH₂OC₂H₄OC₁₋₆ alkyl, —CH₂OC₁₋₆ fluoroalkyl, —C₂H₄OC₁₋₆ fluoroalkyl, —CH₂OCH₂OC₁₋₆ fluoroalkyl, or —CH₂CH₂OCH₂CH₂OC₁₋₆ fluoroalkyl.

In some embodiments, R^{8a} is —O—[(C₁₋₄ alkylene)-O-]ₓ-C₁₋₁₀ alkyl or —O—[(C₁₋₄ alkylene)-O-]ₓ-C₁₋₁₀ fluoroalkyl. In some embodiments, R^{8a} is —O—[(C₁₋₄ alkylene)-O-]_{X}-C₁₋₆ alkyl or —O—[(C₁₋₄ alkylene)-O-]_{X}-C₁₋₆ fluoroalkyl. In some embodiments, R^{8a} is —CH₂OC₁₋₆ alkyl, —CH₂CH₂OC₁₋₆ alkyl, —CH₂OCH₂OC₁₋₆ alkyl, —CH₂CH₂OCH₂CH₂OC₁₋₆ alkyl, —CH₂OC₁₋₆ fluoroalkyl, —CH₂CH₂—O—C₁₋₆ fluoroalkyl, —CH₂OCH₂OC₁₋₆ fluoroalkyl, or —CH₂CH₂OCH₂CH₂OC₁₋₆ fluoroalkyl.

In some embodiments, R^{9a} is H. In some embodiments, R^{9a} is C₁₋₁₀ alkyl or C₁₋₁₀ fluoroalkyl.

In some embodiments, R^{9a} is C₁₋₆ alkyl such as methyl, ethyl and propyl. In some embodiments, R^{9a} is C₁₋₆ fluoroalkyl including without limitation —CF₃, —CH₂CHF₂ or —CF₂CH₃.

In some embodiments, R^{9a} is C₁₋₁₀ alkoxy or C₁₋₆ alkoxy. In some embodiments, R^{9a} is C₁₋₃ alkoxy such as —OCH₃, —OC₂H₅, and —OCH₂CH₂CH₃. In some embodiments, R^{9a} is —OC₁₋₁₀ fluoroalkyl.

In some embodiments, R^{9a} is C₁₋₆ fluoroalkoxy, i.e., —OC₁₋₆ fluoroalkyl. In some embodiments, R^{9a} is —C₁₋₃ fluoroalkoxy such as —OCF₃, —OCH₂CHF₂, —OCH₂CF₃, —OCHFCF₃, —CF₂CF₃, —OCH₂CH₂CF₃, —OCH₂CHFCF₃, —OCH₂CF₂CF₃, and —OCHFCF₂CF₃.

In some embodiments, R^{9a} is —[(C₁₋₄ alkylene)-O-]ₓ-C₁₋₁₀ alkyl or —[(C₁₋₄ alkylene)-O-]ₓ-C₁₋₁₀ fluoroalkyl. In some embodiments, R^{9a} is —[(C₁₋₄ alkylene)-O-]_{X}-C₁₋₆ alkyl or —[(C₁₋₄ alkylene)-O-]ₓ-C₁₋₆ fluoroalkyl. In some embodiments, R^{9a} is —CH₂OC₁₋₆ alkyl, —C₂H₄OC₁₋₆ alkyl, —CH₂OCH₂OC₁₋₆ alkyl, —CH₂CH₂OC₂H₄OC₁₋₆ alkyl, —CH₂OC₁₋₆ fluoroalkyl, —C₂H₄OC₁₋₆ fluoroalkyl, —CH₂OCH₂OC₁₋₆ fluoroalkyl, or —CH₂CH₂OCH₂CH₂OC₁₋₆ fluoroalkyl.

In some embodiments, R^{9a} is —O—[(C₁₋₄ alkylene)-O-]ₓ-C₁₋₁₀ alkyl or —O—[(C₁₋₄ alkylene)-O-]ₓ-C₁₋₁₀ fluoroalkyl. In some embodiments, R^{9a} is —O—[(C₁₋₄ alkylene)-O-]_{X}-C₁₋₆ alkyl or —O—[(C₁₋₄ alkylene)-O-]_{X}-C₁₋₆ fluoroalkyl. In some embodiments, R^{9a} is —CH₂OC₁₋₆ alkyl, —CH₂CH₂OC₁₋₆ alkyl, —CH₂OCH₂OC₁₋₆ alkyl, —CH₂CH₂OCH₂CH₂OC₁₋₆ alkyl, —CH₂OC₁₋₆ fluoroalkyl, —CH₂CH₂—O—C₁₋₆ fluoroalkyl, —CH₂OCH₂OC₁₋₆ fluoroalkyl, or —CH₂CH₂OCH₂CH₂OC₁₋₆ fluoroalkyl.

In some embodiments, R^{10a} is H. In some embodiments, R^{10a} is C₁₋₁₀ alkyl or C₁₋₁₀ fluoroalkyl. In some embodiments, R^{10a} is C₁₋₆ alkyl such as methyl, ethyl and propyl. In some embodiments, R^{10a} is C₁₋₆ fluoroalkyl including without limitation —CF₃, —CH₂CHF₂ or —CF₂CH₃.

In some embodiments, R^{10a} is C₁₋₁₀ alkoxy or C₁₋₆ alkoxy. In some embodiments, R^{10a} is C₁₋₃ alkoxy such as —OCH₃, —OC₂H₅, and —OCH₂CH₂CH₃. In some embodiments, R^{10a} is —OC₁₋₁₀ fluoroalkyl. In some embodiments, R^{10a} is —OC₁₋₆ fluoroalkyl. In some embodiments, R^{10a} is —OC₁₋₃ fluoroalkyl such as —OCF₃, —OCH₂CHF₂, —OCH₂CF₃, —OCHFCF₃, —CF₂CF₃, —OCH₂CH₂CF₃, —OCH₂CHFCF₃, —OCH₂CF₂CF₃, and —OCHFCF₂CF₃.

In some embodiments, R^{10a} is —[(C₁₋₄ alkylene)-O-]ₓ-C₁₋₁₀ alkyl or —[(C₁₋₄ alkylene)-O-]ₓ-C₁₋₁₀ fluoroalkyl. In some embodiments, R^{10a} is —[(C₁₋₄ alkylene)-O-]ₓ-C₁₋₆ alkyl or —[(C₁₋₄ alkylene)-O-]ₓ-C₁₋₆ fluoroalkyl. In some embodiments, R^{10a} is —CH₂OC₁₋₆ alkyl, —C₂H₄OC₁₋₆ alkyl, —CH₂OCH₂OC₁₋₆ alkyl, —CH₂CH₂OC₂H₄OC₁₋₆ alkyl, —CH₂OC₁₋₆ fluoroalkyl, —C₂H₄OC₁₋₆ fluoroalkyl, —CH₂OCH₂OC₁₋₆ fluoroalkyl, or —CH₂CH₂OCH₂CH₂OC₁₋₆ fluoroalkyl.

In some embodiments, R^{10a} is —O—[(C₁₋₄ alkylene)-O-]ₓ-C₁₋₁₀ alkyl or —O—[(C₁₋₄ alkylene)-O-]ₓ-C₁₋₁₀ fluoroalkyl. In some embodiments, R^{10a} is —O—[(C₁₋₄ alkylene)-O-]_{X}-C₁₋₆ alkyl or —O—[(C₁₋₄ alkylene)-O-]_{X}-C₁₋₆ fluoroalkyl. In some embodiments, R^{10a} is —CH₂OC₁₋₆ alkyl, —CH₂CH₂OC₁₋₆ alkyl, —CH₂OCH₂OC₁₋₆ alkyl, —CH₂CH₂OCH₂CH₂OC₁₋₆ alkyl, —CH₂OC₁₋₆ fluoroalkyl, —CH₂CH₂—O—C₁₋₆ fluoroalkyl, —CH₂OCH₂OC₁₋₆ fluoroalkyl, or —CH₂CH₂OCH₂CH₂OC₁₋₆ fluoroalkyl.

For example, the fluorinated ether comprises one or more of bis(2,2,2-trifluoroethoxy)methane (BTFM), 1,1,1,3,3,3-hexafluoro-2-(1,1,1,3,3,3-hexafluoropropan-2-yloxymethoxy)propane, bis(3,3,3-trifluoropropoxy)methane, 1,1,1-trifluoro-3-[(2,2,2-trifluoroethoxy)methoxy]propane, bis(2,2,3,3,3-pentafluoropropoxy)methane, 1,1,1,2,2-pentafluoro-3-((2,2,2-trifluoroethoxy)methoxy)propane, 1,1,2,2-tetrafluoroethyl-2,2,3,3-tetrafluoropropyl ether (TTE), 1H,1H,5H-octafluoropentyl-1,1,2,2-tetrafluoroethyl ether (OTE), bis(2,2,2-trifluoroethyl) ether, 1H,1H,2′H-Perfluorodipropyl ether, 2,2,2-Trifluoroethyl 1,1,2,2-tetrafluoroethyl ether, 1,2-(1,1,2,2-tetrafluoroethoxy)ethane (TFEE), tris(2,2,2-trifluoroethyl)orthoformate (TFEO) and mixtures thereof.

The solvent can comprise the fluorinated ether in an amount in a range from 5 wt % to about 90 wt %. For example, the solvent comprises the fluorinated ether in an amount in a range from about 10 wt % to about 90 wt %, from about 20 wt % to about 80 wt %, from about 25 wt % to about 75 wt %, or from about 55 wt % to about 75 wt %. In some embodiments, the solvent comprises the fluorinated ether in an amount in a range from about 55 wt % to about 75 wt % or from about 60 wt % to about 70 Wt %.

In some embodiments, the fluorine-free ether and the fluorinated ether are present in a weight ratio of 1:20 to 20:1, 1:10 to 10:1, 1:5 to 10:1, 1:3 to 8:1, or 1:1 to 3:1. In some embodiments, the fluorine-free ether and the fluorinated ether are present in a weight ratio in a range from 1:3 to 8:1 or from 1:1 to 3:1.

In some embodiments, the solvent has a boiling point of at least 100° C. at 1 atm. In some embodiments, the solvent has a boiling point of at least 110° C. at 1 atm, at least 120° C. at 1 atm, at least 130° C. at 1 atm, or at least 140° C. at 1 atm.

In some embodiments, each component in the gel electrolyte has a boiling point of at least 100° C., at least 110° C., at least 120° C., at least 130° C. or at least 140° C. at 1 atm. In some embodiments, the gel electrolyte does not include any component with a boiling point lower than 100° C., 110° C., 120° C., 130° C., or 140° C. at 1 atm to ensure the stability and safety.

In some embodiments, the gel polymer electrolyte comprises a fluorine-free ether, fluorinated ether, or both. The solvent is present in an amount of at least 10 wt %, at least 15 wt %, at least 20 wt %, at least 30 wt %, at least 40 wt %, at least 50 wt %, at least 60 wt %, at least 70 wt %, at least 80 wt %, at least 85 wt %, or at least about 90 wt % based on the total weight of the gel polymer electrolyte. For example, the nonaqueous solvent is present in a range from about 15 wt % to about 95 wt %, from about 25 wt % to 95 wt %, from about 50 wt % to 95 wt %, from about 75 wt % to about 90 wt %, from about 30 wt % to about 60 wt %, or from about 40 wt % to about 55 wt %, based on the total weight of the gel polymer electrolyte. In some embodiments, the nonaqueous solvent is present in an amount in a range from 40 wt % to about 55 wt %, or from about 75 wt % to about 90 wt %, based on the total weight of the gel polymer electrolyte.

### Electrolyte Salt

The electrolyte salt may be, for example, a lithium salt, or other salts such as sodium, potassium, magnesium, calcium salts, and the like.

In some embodiments, the electrolyte salt comprises a lithium salt. In some embodiments, the electrolyte salt includes one or more of lithium perchlorate (LiClO₄), lithium hexafluorophosphate (LiPF₆), lithium nitrate (LiNO₃), lithium borofluoride (LiBF₄), lithium hexafluoroarsenide (LiAsF₆), lithium trifluoromethanesulfonate (LiCF₃SO₃), lithium bisperfluoro-ethysulfonylimide (LiBETI), lithium bis(fluorosulfonyl)imide (LiFSI), lithium bis(trifluoromethanesulfonyl)imide (LiN(CF₃SO₂)₂, LiTFSI), lithium bis(oxalato)borate (LiBOB), lithium difluoro(oxalato)borate (LiBF₂C₂O₄, LiDFOB), lithium fluoroalkyl-phosphates (Li[PFₓ(C_{y}F_{2y+1-z}H_{z})₆₋ₓ]) (1≤x≤5, 1≤y≤8, and 0≤z≤2y−1), lithium fluorophosphate (Li₂PO₃F), lithium difluorophosphate (LiDFP), lithium difluoro(bisoxalato)phosphate (LiC₄PO₈F₂), and lithium tetrafluoro oxalato phosphate (LiC₂PO₄F₄), lithium tris(trifluoromethanesulfonyl)methide (LiC(CF₃SO₂)₃), LiF, LiCl, LiBr, LiI, Li₂SO₄, Li₃PO₄, Li₂CO₃, lithium acetate, lithium trifluoromethyl acetate, and lithium oxalate.

In some embodiments, the electrolyte salt comprises LiFSI, LiTFSI or both.

In some embodiments, the electrolyte salt is present in a weight percentage in a range from about 5 wt % to about 85 wt % based on the total weight of the precursor solution or the gel polymer electrolyte. For example, the electrolyte salt has a weight percentage in a range from about 10 wt % to about 75 wt %, from about 15 wt % to about 75 wt %, from about 25 wt % to about 75 wt %, from about 30 wt % to about 70 wt %, from about 40 wt % to about 60 wt %, from about 15 wt % to about 50 wt %, or from about 10 wt % to about 30 wt %, based on the total weight of the precursor solution or the gel polymer electrolyte. In some embodiments, the electrolyte salt can be present in an amount of about 40 wt % to about 60 wt %, based on the total weight of the precursor solution or the gel polymer electrolyte. In some embodiments, the electrolyte salt is present in the electrolyte in an amount of about 10 wt % to about 40 wt %, based on the total weight of the precursor solution or the gel polymer electrolyte.

In some embodiments, the gel polymer electrolyte comprises the nonaqueous solvent in an amount of about 15 wt % to about 85 wt %; the electrolyte salt in an amount of about 5 wt % to about 85 wt %; and the crosslinked polymer in an amount of about 0.1 wt % to about 15 wt %, based on the total weight of the gel polymer electrolyte. In some embodiments, the gel polymer electrolyte of the disclosure comprises the nonaqueous solvent in an amount of about 40 wt % to about 60 wt %; the electrolyte salt in an amount of about 40 wt % to about 60 wt %; and the crosslinked polymer in an amount of about 0.5 wt % to about 2.5 wt %, based on the total weight of the gel polymer electrolytes. In some embodiments, the gel polymer electrolyte of the disclosure comprises the solvent in an amount of about 70 wt % to about 90 wt %; the electrolyte salt in an amount of about 10 wt % to about 30 wt %; and the polymer in an amount of about 0.5 wt % to about 2.5 wt %, based on the total weight of the gel polymer electrolytes.

In some embodiments, the precursor solution of the gel polymer electrolyte comprises the electrolyte salt of at least 15 wt %, at least 20 wt %, or at least 25 wt % based on the total weight of the precursor solution. The high wt % of electrolyte salt is essential for the desired stability and/or ionic conductivity of the electrolyte.

In addition, certain embodiments are directed to compositions for use with electrolytes, batteries, or other electrochemical devices including same, and methods for producing same.

In one aspect, the present disclosure is generally directed to an electrochemical cell including a gel polymer electrolyte as disclosed herein. In certain embodiments, the battery is an LIB, such as a lithium-ion solid-state battery. The electrochemical cell may include an anode, a cathode, and a separator. In some embodiments, the gel polymer electrolyte of the disclosure may be used as the electrolyte of the electrochemical cell, alone and/or in combination with other electrolyte materials.

### Other Additives

In some embodiments, the gel polymer electrolyte of the disclosure may further include an additive. In some embodiments, the additive may provide improved processability, and/or controlled ionic conductivity and mechanical strength. In some embodiments, the additive can be present at a weight percentage of about 1 wt % to about 10 wt % or about 0.01 wt % to about 5 wt %, based on a total weight of the polymer electrolyte. Some additives and other materials as described in WO 2020096632 A1 and US application publication no. 20200144665 A1 and 20200144667 A1 are incorporated herein by reference in its entirety.

In various examples, the present disclosure provides an electrochemical device comprising an anode, a cathode and the gel polymer electrolyte as described herein.

In some embodiments, the anode is a carbon anode, Li anode, Si anode, alloy anode, Li₄Ti₅O₁₂, or made from conversion anode materials. In some embodiments, the carbon anode comprises graphite, soft carbon, hard carbon, or combinations of thereof. In some embodiments, the Li anode comprises Li metal foil, Li metal on Cu, Ni, or stainless steel. In some embodiments, the Si anode comprises Si, Si/Carbon composite, SiOₓ (0≤x<2), SiOₓ (0≤x<2)/carbon composite or a combination thereof. In some embodiments, the alloy anode comprises Sn, SnO₂, Sb, Al, Mg, Bi, In, As, Zn, Ga, B, or a combination thereof. In some embodiments, the conversion anode materials comprise MₐX_{b}, M is Mn, Fe, Co, Ni, or Cu, X is O, S, Se, F, N, or P, a and b are respectively 1 to 4. In some embodiments, the anode is Li metal foil or Li metal on Cu, Ni, or stainless steel.

In various embodiments, a battery is anode free, i.e., only includes anode current collector without anode active material layer. In various embodiments, a battery comprises both anode current collector and anode active material layer.

In some embodiments, the cathode comprises an electroactive material including one or more selected from the group consisting of lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

In some embodiments, the gel polymer electrolyte may exhibit better ionic conductivity than all solid-state electrolytes. In some embodiments, the electrolyte exhibits an ionic conductivity of at least 1.0 mS/cm or at least 2.0 mS/cm at 25° C. In some embodiments, the electrolyte compositions can be thermally stable as none of the components of the electrolyte have a boiling point of less than 100° C.

The electrolyte of any preceding claim, wherein the electrolyte has an oxidation potential of at least 4.25 V over Li/Li+.

In some embodiments, the gel polymer electrolyte of the disclosure is stable (e.g., passing safety testing such as hot box test, overcharge, nail penetration tests, accelerating rate calorimetry, flammability tests, etc.) when comprised in an electrochemical device, e.g., lithium metal batteries.

In some embodiments, the electrolyte compositions of the disclosure may be used to achieve safer, longer-life lithium batteries. In some embodiments, these properties may benefit fast charge and high-power discharge.

In some embodiments, the electrochemical device disclosed herein such as lithium metal battery passes an overcharge test, wherein the electrochemical device is at 100% state-of-charge and is overcharged at 3 mA/cm² charge rate for 1 hour or when 8.5V is reached with a European Council for Automotive Research (EUCAR) hazard level of 4 or below.

In some embodiments, an electrochemical device comprising the gel polymer electrolyte as disclosed herein exhibits a discharge specific capacity of at least 150.0 mAh/g, at least 155.0 mAh/g, at least 160.0 mAh/g, at least 165.0 mAh/g, at least 170.0 mAh/g, at least 175.0 mAh/g or at least 180.0 mAh/g at a charge rate of 0.33C (1.0 mA/cm²) followed by a discharge rate of 0.33C at 25° C.

In some embodiments, an electrochemical device comprising the gel polymer electrolyte as disclosed herein exhibits a discharge specific capacity of at least 100.0 mAh/g, at least 110.0 mAh/g, at least 120.0 mAh/g, at least 125.0 mAh/g, at least 130.0 mAh/g, at least 135.0 mAh/g, at least 140.0 mAh/g, at least 145.0 mAh/g or at least 150.0 mAh/g at a charge rate of 1.0C (3.0 mA/cm²) followed by a discharge rate of 0.33 C at 25° C.

In some embodiments, an electrochemical device comprising the gel polymer electrolyte as disclosed herein exhibits a discharge specific capacity of at least 80.0 mAh/g, at least 85.0 mAh/g, at least 90.0 mAh/g, at least 95.0 mAh/g, at least 100.0 mAh/g, at least 105.0 mAh/g or at least 110.0 mAh/g at a charge rate of 2.0C (6.0 mA/cm²) followed by a discharge rate of 0.33 C at 25° C.

In some embodiments, the electrochemical device maintains a specific capacity of at least 160 mAh/g for at least 100 cycles, at least 150 cycles, at least 200 cycles, at least 250 cycles, at least 300 cycles, at least 350 cycles, at least 400 cycles, at least 450 cycles, at least 500 cycles or at least 550 cycles wherein the charge current is 0.33C (1 mA/cm²) and the discharge current is 1 mA/cm² at 25° C.

In some embodiments, the electrochemical device can be charged at a current density of at least about 7.5 mA/cm², at least about 15 mA/cm², at least about 18 mA/cm², or about 7.5 mA/cm² to about 18 mA/cm².

Also provided herein are electrochemical devices comprising an anode; a cathode; and an electrolyte of the disclosure, wherein the electrochemical device passes an overcharge test, wherein the electrochemical device is at 100% state-of-charge and is overcharged at a 3 mA/cm² charge rate for 1 hour or when 8.5V is reached with a EUCAR hazard level of 4 or below.

In one aspect, the present disclosure generally relates to an electrochemical device comprising the gel polymer electrolyte disclosed herein. The electrochemical device may be a battery, an LIB or a lithium-ion solid-state battery. The battery may be configured for applications such as portable applications, transportation applications, stationary energy storage applications, and the like. Such applications include drone, electric vehicle (EV), electric boat, and electric vertical take-off and landing (eVTOL) aircraft. The device may also be a battery comprising one or more lithium ions electrochemical cells.

In some embodiments, the present disclosure provides a crosslinked polymer which is a standalone polymer network structurally different from an interpenetrating polymer network (IPN). An IPN requires two co-existing polymer networks that structurally interpenetrate each other.

In some embodiments, the polymer electrolyte of the present disclosure does not include any insoluble inorganic components such as inorganic particles. In some embodiments, the polymer electrolyte of the present disclosure may further comprise an inorganic component such as inorganic lithium-ion conductor.

In some embodiments, the polymer electrolyte of the present disclosure between cathode and separator or between anode and separator is a single layer.

Although the disclosed teachings have been described with reference to various applications, methods, compounds, compositions, and materials, it will be appreciated that various changes and modifications to them may be made without departing from the teachings herein. The following examples are provided to better illustrate the disclosed teachings and are not intended to limit the scope of the teachings presented herein. While the present teachings have been described in terms of these exemplary embodiments, the skilled artisan will readily understand that numerous variations and modifications of these exemplary embodiments are possible without undue experimentation. All such variations and modifications are within the scope of the teachings of this disclosure.

### EXAMPLES

### Example 1

### Preparation of Electrolyte

A precursor solution was prepared by mixing a base electrolyte solution with a predetermined amount of acrylate-based Michael acceptor, pentaerythritol tetraacrylate (PETA) (functionality of 4), and amine-based Michael donor, Jeffamine T-403, wherein the base electrolyte solution comprises ˜3.5 M LiFSI in an ether-based solvent. Aza-Michael addition reaction of the precursor solution was conducted at 75° C. to obtain a gel (alternatively quasi-solid or semi-solid) polymer electrolyte of example 1-1 and 1-2. The content of the polymer in the gel polymer electrolyte and the molar ratio of C═C to —NH₂ are listed in Table 1. The content of crosslinked polymer in gel polymer electrolyte is the total weight of Michael acceptor and Michael donor in the precursor solution divided by the total weight of the precursor solution multiplied by 100%.

In some embodiments, the Michael acceptor has a formula of

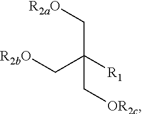

wherein R₁ is ethyl, R₂ₐ, R_{2b} and R_{2c} are each independently selected from the group consisting of

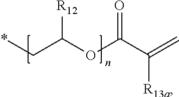

wherein R₁₂ and R₁₃ₐ are each independently H, C₁₋₆ alkyl, C₁₋₆ haloalkyl, C₁₋₆ hydroxyalkyl and C₁₋₆ alkoxy n has a value in a range from 0 to 20.

In some embodiments, the Michael donor is a diamine and has a formula of

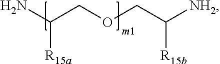

wherein R₁₅ₐ and R_{15b} are each independently selected from the group consisting of H, —CH₃, and —C₂H₅, and m1 has an average value between 2.0 to 10.

TABLE 1
Michael acceptor and donors for preparing gel polymer electrolyte

| Polymer electrolyte | Michael | Michael | Content of | C═C/NH₂ |
|---|---|---|---|---|
| example No. | acceptor | donor | polymer, wt % | molar ratio |
| 1-1 | PETA | T-403 | 9 | 1.5:1 |
| 1-2 | PETA | T-403 | 9 | 1:1 |

### Example 2

Gel polymer electrolytes of examples 2-1, 2-2, 2-3 and 2-4 were prepared similar to example 1 except trimethylolpropane ethoxylate triacrylate (TMPEOTA) (functionality of 3) as the Michael acceptor instead of PETA and 4,7,10-trioxa-1,13-tridecanediamine (TTDDA) as the Michael donor instead of Jeffamine T-403. The content of polymer and the molar ratio of C═C/NH₂ are shown in Table 2.

TABLE 2
Michael acceptor and donors for preparing gel polymer electrolyte

| Polymer | | | Content | |
|---|---|---|---|---|
| electrolyte | Michael | Michael | of polymer, | C═C/NH₂ |
| example No. | acceptor | donor | wt % | molar ratio |
| 2-1 | TMPEOTA | TTDDA | 6 | 2:1 |
| 2-2 | TMPEOTA | TTDDA | 6 | 1.5:1 |
| 2-3 | TMPEOTA | TTDDA | 9 | 2:1 |
| 2-4 | TMPEOTA | TTDDA | 9 | 1.5:1 |

### Example 3

Gel polymer electrolytes of examples 3-1, 3-2, 3-3, 3-4 and 3-5 were prepared similar to example 1 with different polymer contents and molar ratios of C═C/NH₂ as shown in Table 3. Comparative example 1 was prepared by radical polymerization of a comparative precursor solution comprising the base electrolyte solution and PETA as the monomer and AIBN as the radical initiator. Example 3-6 and 3-7 failed to form a uniform gel electrolyte with polymer content of 1 wt % and 2 wt %, respectively.

TABLE 3
Michael acceptor and donors for preparing gel polymer electrolyte

| | Michael | Michael | Polymer content, | C═C/—NH₂ |
|---|---|---|---|---|
| No. | acceptor | donor | wt % | molar ratio |
| 3-1 | PETA | TTDDA | 3 | 2:1 |
| 3-2 | PETA | TTDDA | 3 | 1.5:1 |
| 3-3 | PETA | TTDDA | 3 | 1:1 |
| 3-4 | PETA | TTDDA | 9 | 2:1 |
| 3-5 | PETA | TTDDA | 9 | 1:1 |
| 3-6 | PETA | TTDDA | 1 | 1.5:1 |
| 3-7 | PETA | TTDDA | 2 | 1.5:1 |
| Comparative 1 | PETA | n/a | 1.5 | n/a |

The ionic conductivity of the electrolyte was calculated based on the bulk resistance obtained by electrochemical impedance spectroscopy (EIS) measurements at 25° C. The representative polymer electrolyte example 3-4 exhibited an ionic conductivity of 3.09±0.49 mS/cm, which is comparable to the comparative example 1 (5.26±0.38 mS/cm) but significantly higher than the ionic conductivity of polymer electrolytes prepared by Wang J et al [Wang J et al, ACS Applied Polymer Materials 6.4 (2024): 2041-2048; Wang J, et al., Macromolecules 56.6 (2023): 2484-2493] or disclosed in CN11.1944099A.

Li stripping/plating coulombic efficiency (CE) is a critical parameter for the evaluation of electrolyte stability on Li metal anode. The Li stripping/plating CE was obtained by stripping/plating cycles in Li/Cu cells comprising Li metal as anode, Cu foil as cathode, microporous membrane as a separator, and electrolytes as prepared.

TABLE 4
Initial CE and average CE of Li/Cu cells

| Example No. | Initial CE, % | Ave CE, % |
|---|---|---|
| 3-1 | 93.85 ± 1.2 | 99.14 ± 0.02 |
| 3-2 | 94.24 ± 1.6 | 99.36 ± 0.02 |
| 3-3 | 90.93 ± 1.4 | 98.49 ± 0.40 |
| 3-4 | 93.13 ± 0.8 | 99.30 ± 0.02 |
| 3-5 | 92.88 ± 1.1 | 99.26 ± 0.04 |
| Comparative 1 | 96.25 ± 0.6 | 99.27 ± 0.03 |

The initial CE and average CE (Ave. CE) are summarized in Table 4. Average CE is total Li stripping cycle capacity divided by total Li plating cycle capacity using Aurbach CE protocol with a current density of 1.0 mA/cm², a capacity of 3.0 mAh/cm², and a total of 40 stripping/plating cycles. [Adv. Energy Mater. 2017, 1702097]. The average CE of comparative example 1, example 3-2, and example 3-4 are 99.27%, 99.36%, and 99.30%, respectively. Because the CE is already above 99.0%, a small increase in CE could lead to significant improvements in cycling performance.

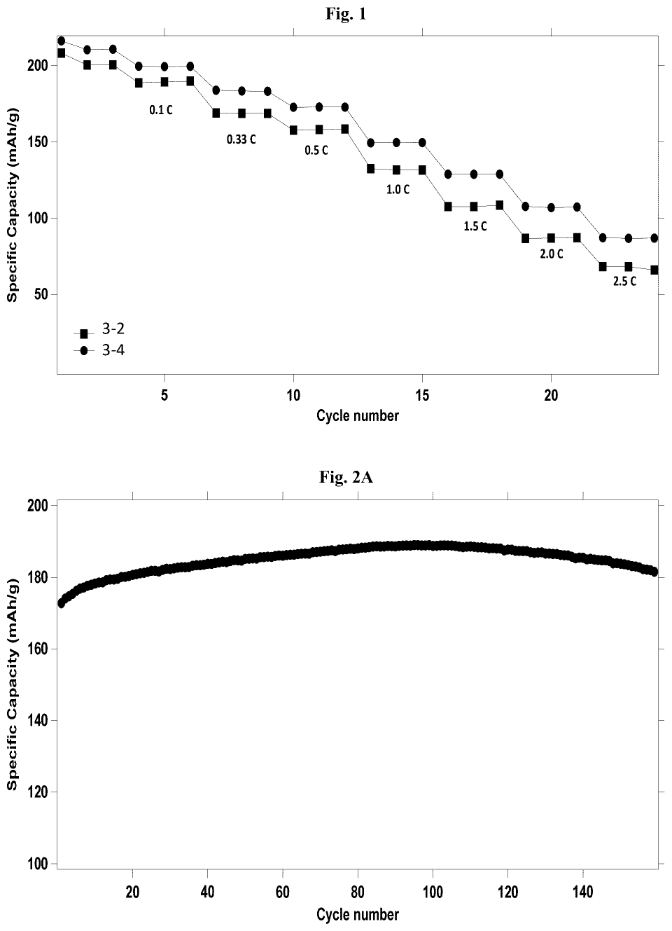

FIG. 1 shows the specific capacities at various charge rates (1.0C=3.0 mAh/cm², up to 7.5 mA/cm²) of a coin cell comprising Li metal as anode, NMC811 composite electrode as cathode, microporous membrane as separator, and an electrolyte of example 3-2 and example 3-4.

As shown in FIG. 1, the coin cells comprising the polymer electrolyte of examples 3-2 and 3-4 exhibited a discharge specific capacity of around 168.9 mAh/g and 183.8 mAh/g, respectively, at a charge rate of 0.33C followed by a discharge rate of 0.33C at 25° C.

The coin cells comprising the polymer electrolyte of examples 3-2 and 3-4 exhibited a discharge specific capacity of around 132.3 mAh/g and 149.3 mAh/g, respectively, at a charge rate of 1.0C followed by at a discharge rate of 0.33C.

The coin cells comprising the polymer electrolyte of examples 3-2 and 3-4 exhibited a discharge specific capacity of around 88.7 mAh/g and 107.6 mAh/g, respectively, at a charge rate of 2.0C, followed by a discharge rate of 0.33C.

Cycling performance: A battery with a cathode, an anode, a separator, and an electrolyte was discharged and charged between various voltage ranges at 25° C. using a battery tester with various current rates. Cycle life is determined by the number of cycles for the battery cell to reach 80% of its original capacity (capacity retention).

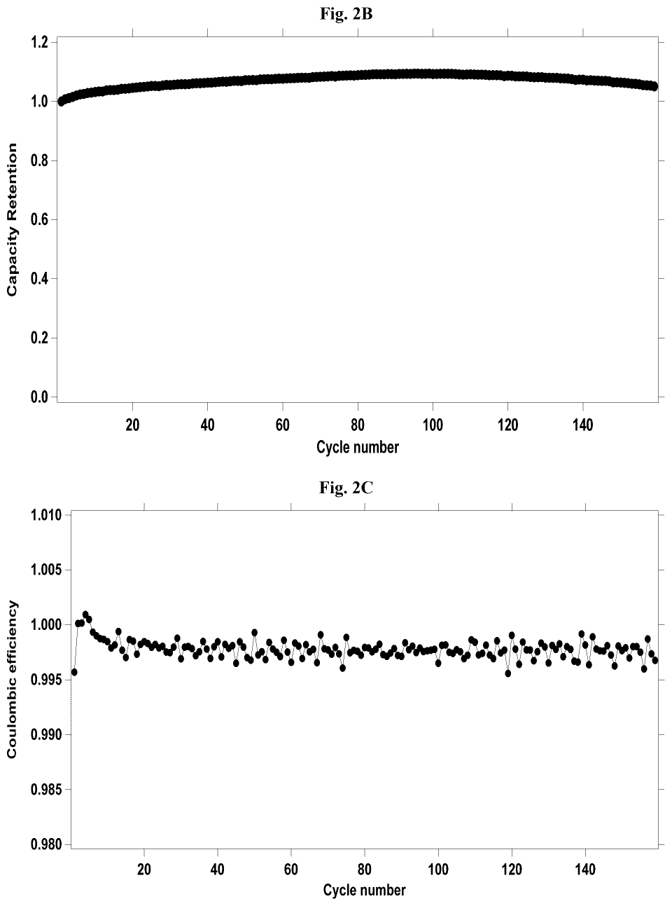

A 0.75 Ah multi-layer pouch cell comprising Li metal as anode, microporous membrane as separator, NMC811 as cathode, and polymer electrolyte example 3-2 as electrolyte was cycled between 2.8 V to 4.25 V at 25° C. using a charge current density of 1.0 mA/cm² (0.33C) and discharge current density of 1.0 mA/cm² under an external pressure in a range from 0.2 MPa to 5.0 MPa. The specific discharge capacity, discharge capacity retention, and CE are shown in FIG. 2A, FIG. 2B, and FIG. 2C, respectively. The initial discharge specific capacity was 172.7 mAh/g. After 150 cycles, the pouch cell did not show any decay and exhibited a discharge capacity of around 183.7 mAh/g. The coulombic efficiency (CE) is high and consistently greater than 99.5%.

### Comparative Example 2

The content of polymer in the gel polymer electrolyte is critical to achieve desired ionic conductivity for practical applications. For example, the gel polymer electrolytes with high polymer content prepared by Wang J et al using poly(ethylene glycol) diacrylate (PEGDA) as Michael acceptor and TTDDA as Michael donor exhibited a poor ionic conductivity of no higher than 0.1 mS/cm at 30° C. [Wang J et al, ACS Applied Polymer Materials 6.4 (2024): 2041-2048; Wang J, et al., Macromolecules 56.6 (2023): 2484-2493]. However, a Michael acceptor with only two C═C groups (e.g., PEGDA) could lead to a non-uniform gel polymer electrolyte or could not form a gel polymer electrolyte. To demonstrate the influence and criticality of the functionality of the Michael accepter, comparative examples 2-1, 2-2, 2-3, and 2-4 were prepared similar to Example 3 except PEGDA (Mn ˜700) (functionality of 2) as Michael acceptor instead of PETA. The content of polymer and the molar ratio of C═C/NH₂ are shown in Table 5. Comparative examples 2-1, 2-2, 2-3, and 2-4 failed to form a gel polymer electrolyte and remained as liquid after heating at 75° C. for 72 h, indicating that Michael acceptor with three or more C═C groups is essential for forming gel electrolyte with low polymer content (≤15 wt %).

TABLE 5
Michael acceptor and donors for preparing gel polymer electrolyte

| | Michael | Michael | Content of | C═C/NH₂ |
|---|---|---|---|---|
| Example No. | acceptor | donor | polymer, wt % | molar ratio |
| Comparative example | PEGDA | TTDDA | 3 | 1.5:1 |
| 2-1 | | | | |
| Comparative example | PEGDA | TTDDA | 6 | 1.5:1 |
| 2-2 | | | | |
| Comparative example | PEGDA | TTDDA | 9 | 1.5:1 |
| 2-3 | | | | |
| Comparative example | PEGDA | TTDDA | 15 | 1.5:1 |
| 2-4 | | | | |

### Comparative Example 3

The solubility of Michael donor in the precursor solution is critical to the formation of uniform gel polymer electrolyte. In addition, high electrolyte salt concentration is essential for the desired stability and/or ionic conductivity of the electrolyte. CN111944099A developed polymer electrolytes using PEI as Michael donor in a precursor solution comprising 20 wt % to 60 wt % Li salt and alcohol solvent. However, alcohol solvents are not stable in most electrochemical devices such as lithium-ion batteries and PEI has poor solubility in other commonly used non-aqueous solvents such as ether. Comparative examples 3-1, 3-2, and 3-3 were prepared by mixing 3 wt % branched PEI (Mw ˜800) in the base electrolyte solution comprises LiFSI and ether-based solvent. The content of LiFSI and solubility of PEI are shown in Table 6. PEI is insoluble in the ether-based electrolyte with high Li salt concentration (≥20 wt % LiFSI).

TABLE 6
Solubility test of PEI in base electrolyte solution

| Example No. | LiFSI, wt % | PEI solubility |
|---|---|---|
| Comparative example 3-1 | 20 | insoluble |
| Comparative example 3-2 | 25 | insoluble |
| Comparative example 3-3 | 35 | insoluble |

### ASPECTS

In a first aspect, the present disclosure provides a precursor solution and a gel polymer electrolyte prepared therefrom, the precursor solution comprising:
a nonaqueous solvent;
an electrolyte salt;
a Michael donor comprising at least two primary amine (—NH₂) groups; and
a Michael acceptor comprising three or more carbon-carbon double bond groups (C═C), wherein the Michael donor has a molecular weight of no greater than 600 Daltons and is fully dissolved in the precursor solution, and the Michael donor can react with the Michael acceptor via Aza-Michael addition to form a crosslinked polymer.

In a second aspect according to the first aspect, the electrolyte salt is present at a weight percentage of at least 20 wt % in the precursor solution.

In a third aspect according to the first aspect, the nonaqueous solvent is chemically inert to a lithium metal. In some embodiments, the nonaqueous solvent is free of groups reactive with lithium metal.

In a fourth aspect according to the first aspect, the precursor solution is substantially free of —OH such as alcohol solvents.

In a fifth aspect according to the first aspect, the total weight of Michael acceptor and Michael donor is no greater than 15.0 wt % based on the total weight of the precursor solution.

In a sixth aspect according to the first aspect, the Aza-Michael addition is performed in the absence of catalyst other than the electrolyte salt.

In a seventh aspect according to the first aspect, the Michael acceptor is represented by a formula selected from the group consisting of

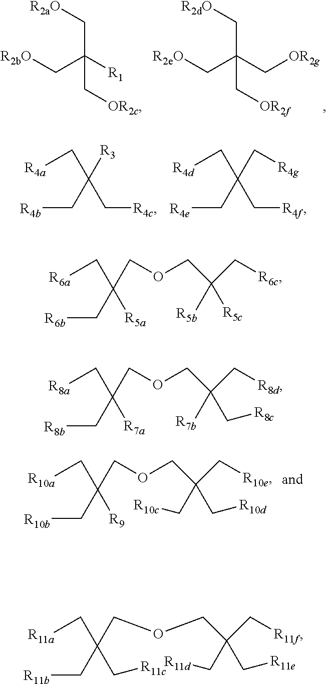

wherein R₁, R₃, R₅ₐ, R_{5b}, R_{5c}, R₇ₐ, R_{7b} and R₉ are each independently selected from the group consisting of H, halogen, —OH, C₁₋₆ alkyl, C₁₋₆ haloalkyl, C₁₋₆ hydroxyalkyl, and C₁₋₆ alkoxy,
R₂ₐ, R_{2b}, R_{2c}, R_{2d}, R₂ₑ, R_{2f} and R_{2g} are each independently

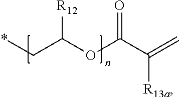

wherein R₁₂ and R₁₃ₐ are each independently H, C₁₋₆ alkyl, C₁₋₆ haloalkyl, C₁₋₆ hydroxyalkyl, and C₁₋₆ alkoxy, n has an average value in a range from 0 to 20, * indicates the point of attachment,
R₄ₐ, R_{4b}, R_{4c}, R_{4d}, R₄ₑ, R_{4f}, R_{4g}, R₆ₐ, R_{6b}, R_{6c}, R₈ₐ, R_{8b}, R_{8c}, R_{8d}, R₁₀ₐ, R_{10b}, R_{10c}, R_{10d}, R₁₀ₑ, R₁₁ₐ, R_{11b}, R_{11c}, R_{11d}, R₁₁ₑ and R_{11f} are each independently selected from the group consisting of

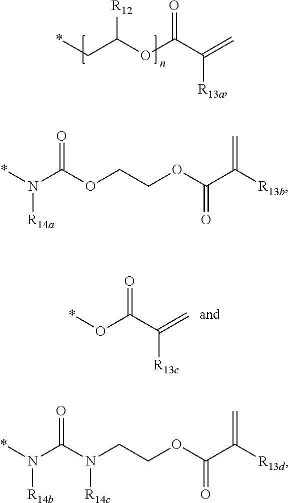

wherein R₁₃ₐ, R_{13b}, R_{13c}, R_{13d}, R₁₄ₐ, R_{14b}, and R_{14c} are each independently selected from the group consisting of H, C₁₋₆ alkyl, C₁₋₆ haloalkyl, C₁₋₆ hydroxyalkyl, and C₁₋₆ alkoxy.

In an eighth aspect according to the first aspect, Michael acceptor comprises at least one selected from the group consisting of pentaerythritol tetra[meth]acrylate, tris[2-(acryloyloxy)ethyl]isocyanurate (TAEI), di(trimethylolpropane)tetra[meth]acrylate, trimethylolpropane propoxylate tri[meth]acrylate, trimethylolpropane tri[meth]acrylate, pentaerythritol tri[meth]acrylate, dipentaerythritol hexa[meth]acrylate, and a mixture thereof.

In a nineth aspect according to the first aspect, the Michael donor contains two or more primary amine groups each attached to one end of a polyether backbone comprising at least one selected from the group consisting of ethylene oxide (EO) and propylene oxide (PO).

In a tenth aspect according to the first aspect, the primary amine group and the carbon-carbon double bond group are present in a molar ratio in a range from 1.0 to 2.0.

In an eleventh aspect according to the first aspect, the nonaqueous solvent comprises one selected from the group consisting of diethyl ether, dimethoxy methane, diethoxy methane, dimethoxy ethane, 1,2-diethoxyethane, 1,1-diethoxyethane, 1,1-dipropoxyethane, 1,2-dipropoxyethane, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, tetrahydrofuran, dioxolane, tetrahydropyran, 1,4-dioxane, 1,3-dioxane, ethylene carbonate, diethyl carbonate, dimethyl carbonate, ethyl methyl carbonate, propylene carbonate, fluoroethylene carbonate, vinylene carbonate, succinonitrile, glutaronitrile, hexanenitrile, malononitrile, dimethyl sulfoxide, 1,3-propane sultone, sulfolane, dimethyl sulfone, ethyl methyl sulfone, ethyl vinyl sulfone, vinyl sulfone, methyl vinyl sulfone, phenyl vinyl sulfone, N-propyl-N-methylpyrrolidinium bis(fluorosulfonyl)imide, N-butyl-N-methylpyrrolidinium bis(fluorosulfonyl)imide, N-propyl-N-methylpiperidinium bis(fluorosulfonyl)imide, 1-methyl-1-(2-methoxyethyl) pyrrolidinium bis(fluorosulfonyl)imide, 1-ethyl-3-methylimidazolium bis(fluorosulfonyl)imide, trimethyl phosphate, triethyl phosphate, poly(ethylene oxide), and a combination thereof.

In a twelfth aspect according to the first aspect, the nonaqueous solvent has a weight percentage in a range from 10 wt % to 90 wt % in the precursor solution.

In a thirteenth aspect according to the first aspect, the nonaqueous solvent comprises a fluorine-free ether and a fluorinated ether.

In a fourteenth aspect, the present disclosure provides a gel polymer electrolyte obtained from the precursor solution according to the first aspect.

In a fifteenth aspect according to the fourteenth aspect, the gel polymer electrolyte exhibits an ionic conductivity of at least 1.0 mS/cm at 25° C.

In a sixteenth aspect according to the fourteenth aspect, the crosslinked polymer is obtained by an in situ polymerization after injecting a mixture comprising the electrolyte salt, the nonaqueous solvent, the Michael acceptor and the Michael donor into an assembly comprising a cathode, an anode and a separator therebetween.

In a seventeenth aspect according to the fourteenth aspect, the crosslinked polymer is obtained by an in situ polymerization after applying a mixture comprising the electrolyte salt, the nonaqueous solvent, the Michael acceptor and the Michael donor to a separator to form a coating thereon followed by a polymerization to form an electrolyte-separator assembly.

In an eighteenth aspect according, the present disclosure provides an electrochemical device comprising an anode and the gel polymer electrolyte according to the fourteenth aspect.

In a nineteenth aspect according to the eighteenth aspect, the anode comprises lithium metal or lithium alloy.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

We claim:

1. A precursor solution for a gel polymer electrolyte, the precursor solution comprising:
a nonaqueous solvent;
an electrolyte salt;
a Michael donor comprising at least two primary amine (—NH₂) groups; and
a Michael acceptor comprising three or more carbon-carbon double bond groups (C═C), wherein the Michael donor has a molecular weight of no greater than 600 Daltons and is fully dissolved in the precursor solution, and the Michael donor can react with the Michael acceptor via Aza-Michael addition to form a crosslinked polymer.

2. The precursor solution of claim 1, wherein the electrolyte salt is present at a weight percentage of at least 20 wt % in the precursor solution.

3. The precursor solution of claim 1, wherein the nonaqueous solvent is free of groups reactive with lithium metal.

4. The precursor solution of claim 1, wherein the nonaqueous solvent is free of —OH.

5. The precursor solution of claim 1, wherein the total weight of Michael acceptor and Michael donor is no greater than 15 wt % based on the total weight of the precursor solution.

6. The precursor solution of claim 1, wherein the Aza-Michael addition is performed in the absence of catalyst other than the electrolyte salt.

7. The precursor solution of claim 1, wherein the Michael acceptor is represented by a formula selected from the group consisting of 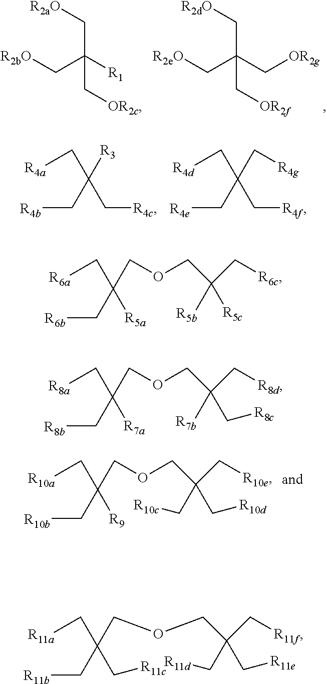
wherein R₁, R₃, R₅ₐ, R_{5b}, R_{5c}, R₇ₐ, R_{7b} and R₉ are each independently selected from the group consisting of H, halogen, —OH, C₁₋₆ alkyl, C₁₋₆ haloalkyl, C₁₋₆ hydroxyalkyl, and C₁₋₆ alkoxy,
R₂ₐ, R_{2b}, R_{2c}, R_{2d}, R₂ₑ, R_{2f} and R_{2g} are each independently 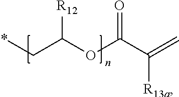
wherein R₁₂ and R₁₃ₐ are each independently H, C₁₋₆ alkyl, C₁₋₆ haloalkyl, C₁₋₆ hydroxyalkyl, and C₁₋₆ alkoxy, n has an average value in a range from 0 to 20, * indicates the point of attachment,
R₄ₐ, R_{4b}, R_{4c}, R_{4d}, R₄ₑ, R_{4f}, R_{4g}, R₆ₐ, R_{6b}, R_{6c}, R₈ₐ, R_{8b}, R_{8c}, R_{8d}, R₁₀ₐ, R_{10b}, R_{10c}, R_{10d}, R₁₀ₑ, R₁₁ₐ, R_{11b}, R_{11c}, R_{11d}, R₁₁ₑ and R_{11f} are each independently selected from the group consisting of 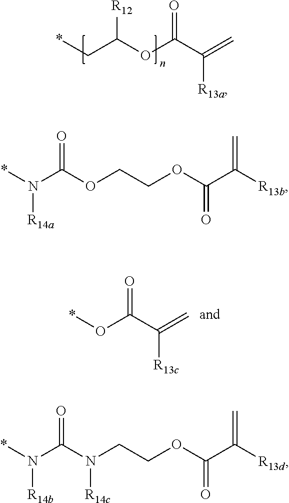
wherein R₁₃ₐ, R_{13b}, R_{13c}, R_{13d}, R₁₄ₐ, R_{14b}, and R_{14c} are each independently selected from the group consisting of H, C₁₋₆ alkyl, C₁₋₆ haloalkyl, C₁₋₆ hydroxyalkyl, and C₁₋₆ alkoxy.

8. The precursor solution of claim 1, wherein the Michael acceptor comprises at least one selected from the group consisting of pentaerythritol tetra[meth]acrylate, tris[2-(acryloyloxy)ethyl]isocyanurate (TAEI), di(trimethylolpropane)tetra[meth]acrylate, trimethylolpropane propoxylate tri[meth]acrylate, trimethylolpropane tri[meth]acrylate, pentaerythritol tri[meth]acrylate, dipentaerythritol hexa[meth]acrylate, and a mixture thereof.

9. The precursor solution of claim 1, wherein the Michael donor contains two or more primary amine groups each attached to one end of a polyether backbone comprising at least one selected from the group consisting of ethylene oxide (EO) and propylene oxide (PO).

10. The precursor solution of claim 1, wherein the primary amine group and the carbon-carbon double bond group are present in a molar ratio in a range from 1.0 to 2.0.

11. The precursor solution of claim 1, wherein the nonaqueous solvent comprises one selected from the group consisting of diethyl ether, dimethoxy methane, diethoxy methane, dimethoxy ethane, 1,2-diethoxyethane, 1,1-diethoxyethane, 1,1-dipropoxyethane, 1,2-dipropoxyethane, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, tetrahydrofuran, dioxolane, tetrahydropyran, 1,4-dioxane, 1,3-dioxane, ethylene carbonate, diethyl carbonate, dimethyl carbonate, ethyl methyl carbonate, propylene carbonate, fluoroethylene carbonate, vinylene carbonate, succinonitrile, glutaronitrile, hexanenitrile, malononitrile, dimethyl sulfoxide, 1,3-propane sultone, sulfolane, dimethyl sulfone, ethyl methyl sulfone, ethyl vinyl sulfone, vinyl sulfone, methyl vinyl sulfone, phenyl vinyl sulfone, N-propyl-N-methylpyrrolidinium bis(fluorosulfonyl)imide, N-butyl-N-methylpyrrolidinium bis(fluorosulfonyl)imide, N-propyl-N-methylpiperidinium bis(fluorosulfonyl)imide, 1-methyl-1-(2-methoxyethyl) pyrrolidinium bis(fluorosulfonyl)imide, 1-ethyl-3-methylimidazolium bis(fluorosulfonyl)imide, trimethyl phosphate, triethyl phosphate, poly(ethylene oxide), and a combination thereof.

12. The precursor solution of claim 1, wherein the nonaqueous solvent has a weight percentage in a range from 10 wt % to 90 wt % in the precursor solution.

13. The precursor solution of claim 1, wherein the nonaqueous solvent comprises a fluorine-free ether and a fluorinated ether.

14. A gel polymer electrolyte obtained from the precursor solution of claim 1.

15. The gel polymer electrolyte of claim 14, wherein the gel polymer electrolyte exhibits an ionic conductivity of at least 1.0 mS/cm at 25° C.

16. The gel polymer electrolyte of claim 14, wherein the crosslinked polymer is obtained by an in situ polymerization after injecting a mixture comprising the electrolyte salt, the nonaqueous solvent, the Michael acceptor and the Michael donor into an assembly comprising a cathode, an anode and a separator therebetween.

17. The gel polymer electrolyte of claim 14, wherein the crosslinked polymer is obtained by an in situ polymerization after applying a mixture comprising the electrolyte salt, the nonaqueous solvent, the Michael acceptor and the Michael donor to a separator to form a coating thereon followed by a polymerization to form an electrolyte-separator assembly.

18. An electrochemical device comprising an anode and the gel polymer electrolyte of claim 14.

19. The electrochemical device of claim 18, wherein the anode comprises lithium metal or lithium alloy.
